(19) United States
(12) Patent Application Publication
(10) Pub. No.: US 2011/0173917 A1
(43) Pub. Date: Jul. 21, 2011

(54) FAST COMBINATION DOOR OR WINDOW STRUCTURE

(76) Inventor: Kuo-Ying Kan, Mountainside, NJ (US)

(21) Appl. No.: 12/689,765

(22) Filed: Jan. 19, 2010

(51) Int. Cl. E06B 3/58

(52) U.S. Cl. 52/656.2

(57) ABSTRACT

The present invention includes two first frame strips, one side of each of the first frame strips is fitted with a first gripping portion, and the two first gripping portions are disposed so as to mutually correspond; and two second frame strips, which are respectively disposed at the upper and lower two ends of the two first frame strips, and together with the two first frame strips fabricate a frame. One side of each of the second frame strips is fitted with a second gripping portion, and the two second gripping portions are disposed so as to mutually correspond. Accordingly, a door or window structure is fabricated by means of the two first gripping portions and the two second gripping portions gripping a plate body.

### BACKGROUND OF THE INVENTION

(a) Field of the Invention

The present invention relates to a fast combination door or window structure, and more particularly to a door or window structure enabling convenient disassembly and fast assemble thereof.

(b) Description of the Prior Art

Windows are Indispensable structures in all current buildings, and apart from being able to separate the interior from the external air, windows can also serve to effect soundproofing effectiveness.

However, the majority of current door or window structures are fabricated from four frame strips, in which each frame strip is respectively provided with a groove, thereby enabling each of the grooves to be respectively disposed around the periphery of a plate body (such as glass, and the like) to achieve the effectiveness to fixedly secure the plate body.

Furthermore, plastic cement is additionally added in the groove of each frame strip in the majority of door or window structures in order to enable the plate body to be stably disposed in the grooves, in which the plastic cement is provided with plasticity. Hence, when the plate body is installed in the grooves, deformation of the plastic cement occurs, and fills the gaps between the plate body and the grooves, thereby achieving sealing effectiveness between the grooves and the plate body.

Accordingly, the plate body stably fixed in each of the frame strips and use of the plastic cement to achieve sealing effectiveness enables the door or window structure to achieve sealing the interior off from external air and provide soundproofing effectiveness. However, assembly of such door or window structures is considerably inconvenient, and deformation of the plastic cement easily disenables stable placement within the grooves. Hence, the technical means of the present invention intends to resolve and improve the aforementioned problems.

### SUMMARY OF THE INVENTION

The primary objective of the present invention lies in providing a door or window structure enabling convenient disassembly and fast assemble thereof.

In order to achieve the aforementioned objective, the fast combination door or window structure of the present invention is used to grip a plate body, and comprises two first frame strips, in which one side of each of the first frame strips is fitted with a first gripping portion, and the two first gripping portions are mutually corresponding; and two second frame strips, which are respectively disposed at the upper and lower two ends of the two first frame strips, and together with the two first frame strips fabricate a frame. One side of each of the second frame strips is fitted with a second gripping portion, and the two second gripping portions are mutually corresponding. Accordingly, a door or window structure is fabricated by means of the two first gripping portions and the two second gripping portions gripping the plate body.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a planar schematic view of the present invention.

FIG. 2 is an exploded elevational view of the present invention.

FIG. 3 is a first cross-sectional schematic view of the present invention.

FIG. 4 is a second cross-sectional schematic view of the present invention.

FIG. 5 is a schematic view of the bottom portion depicting disposition of a rolling member according to the present invention.

### DETAILED DESCRIPTION OF THE PREFERRED EMBODIMENTS

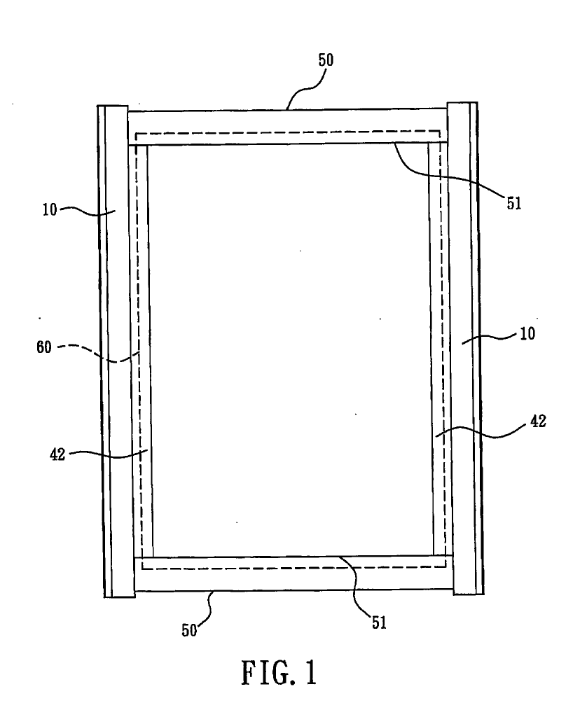

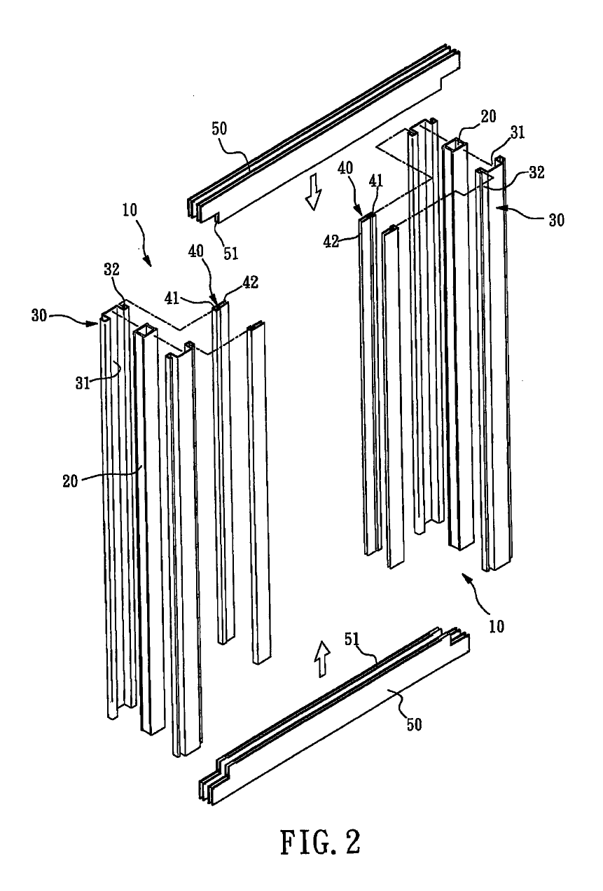

Referring to FIG. 1 and FIG. 2, which show a fast combination door or window structure of the present invention, which is used to retain a plate body 60, comprising:

Two first frame strips 10, and the two first frame strips 10 are disposed so as to mutually correspond, wherein each of the first frame strips 10 of the embodiment is structured from a main body 11 and two holding members 40. The main body 11 in the present embodiment is structured from a cylindrical body 20 and two side plates 30, wherein each of the side plates 30 is provided with a groove 31, and two sides of the groove 31 are respectively provided with a C opening 32. Each of the holding members 40 is provided with a connecting portion 41 and a first holding gripping portion 42, in which the connecting portion 41 corresponds to the C opening 32 of the side plate 30, and can be retained within the C opening 32. Moreover, the first gripping portion 42 approximately resembles a squared-off C-shape, and is provided with a clamping elastic force.

Two second frame strips 50, the two second frame strips 50 are disposed so as to mutually correspond, and are respectively disposed at the upper and lower two ends of the two corresponding first frame strips 10, and thereby together with the two first frame strips 10 forms a frame. Each of the second frame strips 50 in the embodiment is provided with two second gripping portions 51, and each of the second gripping portions 51 approximately resembles a squared-off C-shape, and is provided with a clamping elastic force.

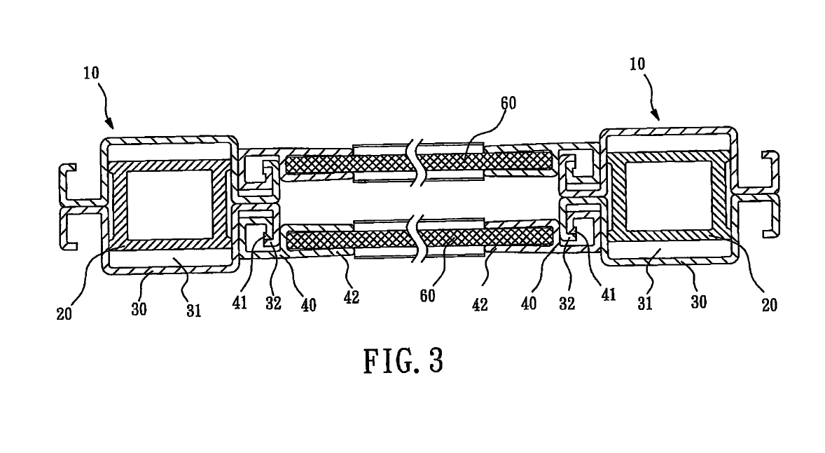

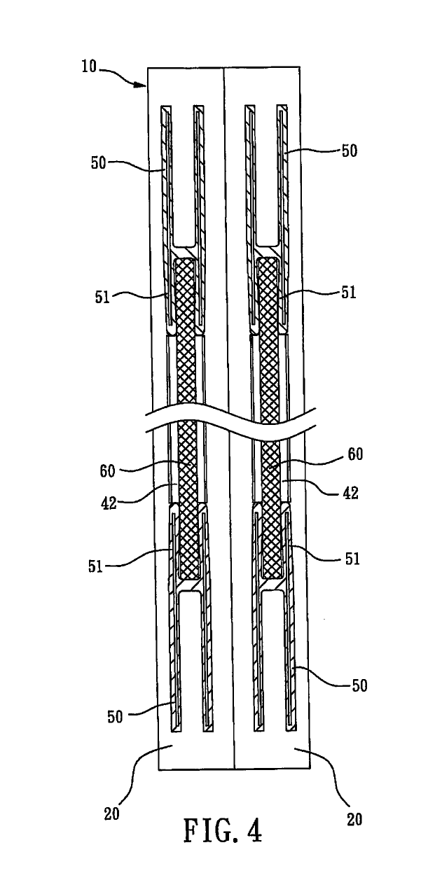

Referring to FIG. 3 and FIG. 4, when fitting the frame together, the cylindrical body 20 of each of the first frame strips 10 is retained within the respective groove 31 of the two side plates 30, thereby causing the two side plates 30 to respectively cover the outer sides of each of the cylindrical bodies 20. Then the holding members 40 are retained within the respective C openings 32 of the side plates 30 using the connecting portions 41, thereby fixedly securing the holding members 40 to one side of the side plate 30, and the first gripping portions 42 of the holding members 40 are used to grip the plate body 60, thereby enabling the two first frame strips 10 to be respectively fixed to the two corresponding sides of the plate body 60.

The two second frame strips 50 are then disposed on the upper and lower two ends of the corresponding first frame strips 10, thereby enabling the second gripping portions 51 on the second frame strips 50 to respectively grip the plate body 60 and the adjacent sides of the first frame strips 10. Accordingly, a door or window structure is fabricated using the two first frame strips 10 and the two second frame strips 50 respectively gripping the periphery of the plate body 60.

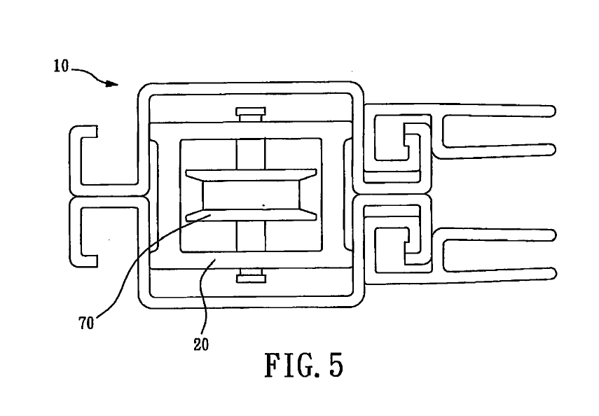

Referring to FIG. 5, in which a rolling member 70 is further disposed at one end of each of the first frame strips 10, and in the embodiment, the rolling member 70 is disposed in the interior of the cylindrical body 20 to enable rolling of the rolling member 70 at one end of the first frame strip 10, thereby enabling the entire window structure to achieve sliding effectiveness by means of the rolling members 70.

In conclusion, the fast combination door or window structure of the present invention is able to use the two first frame strips 10 and the two second frame strips 50 to fabricate a frame, and the two corresponding first gripping portions 42 and the two corresponding second gripping portions 51 are used to grip the periphery of the plate body 60, thereby fabricating a door or window structure provided with disassembling convenience and fast combination effectiveness.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A fast combination door or window structure, used to retain a plate body, comprising:
two first frame strips, one side of each of the first frame strips is provided with a first gripping portion, and the two first gripping portions are disposed so as to mutually correspond; and
two second frame strips, two second frame strips are respectively disposed at the upper and lower two ends of the two first frame strips, and together with the two first frame strips forms a frame, one side of each of the second frame strips is provided with a second gripping portion, and the two second gripping portions are disposed so as to mutually correspond, the two first gripping portions and the two second gripping portions are used to grip the plate body.

2. The fast combination door or window structure according to claim 1, wherein each of the first frame strips is structured from a main body and holding members connected to one side of the main body, and the first gripping portions are fitted to one side of the holding members.

3. The fast combination door or window structure according to claim 2, wherein the first gripping portions approximately resemble squared-off C-shapes.

4. The fast combination door or window structure according to claim 2, wherein the main body is fabricated from a cylindrical body and two corresponding side plates, the two side plates are disposed so as to mutually correspond and cover the outer sides of the cylindrical body.

5. The fast combination door or window structure according to claim 4, wherein one side of the side plate is provided with a C opening, each of the holding members is provided with a connecting portion corresponding to one side of the first gripping portion, and fitting the connecting portions within the C openings is used to achieve connecting the side plates to the holding members.

6. The fast combination door or window structure according to claim 1, wherein the second gripping portion approximately resembles a squared-off C-shape.
